(19) United States
(12) Patent Application Publication
(10) Pub. No.: US 2026/0179023 A1
(43) Pub. Date: Jun. 25, 2026

(54) REAL-TIME CONVERSATION ANALYZER AND DECISION ENABLER

(71) Applicant: Oracle International Corporation, Redwood Shores, CA (US)

(72) Inventors: Sudhir Arthanat, Bangalore (IN); Murali Gururajan, Hosur (IN)

(73) Assignee: Oracle International Corporation, Redwood Shores, CA (US)

(21) Appl. No.: 18/988,181

(22) Filed: Dec. 19, 2024

(51) Int. Cl. G06Q 10/0637; G06F 40/35; G06N 20/00; G06T 11/20

(52) U.S. Cl. CPC G06Q 10/0637; G06F 40/35; G06N 20/00; G06T 11/26

(57) ABSTRACT

A Real-Time Enterprise Conversation Analyzer and Decision Enabler (RECA&DE) that enhances the capabilities of enterprise applications, transforming them from transactional or operational support systems into decision support systems. In one aspect, the RECA&DE is capable of performing the following: generating a first graphical user interface for implementing a decision support module within an enterprise application, obtaining data for a discussion event from the enterprise application based on input received via the first graphical user interface, transferring event data to a discussion service, receiving feedback data from an artificial-intelligence platform, the feedback data comprises sentiment data derived by the artificial-intelligence platform based on transcript data generated from conversations of the participants using the discussion service, analyzing the feedback data, and rendering one or more dashboards in a second graphical user interface based on analyzing of the feedback data.

### FIELD

The present disclosure relates generally to decision support systems, and more particularly, to a Real-Time Enterprise Conversation Analyzer and Decision Enabler (RECA&DE) that enhances the capabilities of enterprise applications, transforming them from transactional/operational support systems into decision support systems.

### BACKGROUND

In today's fast-paced and highly competitive business environment, organizations are increasingly reliant on decision support systems (DSS) to enhance their decision-making processes. Decision support systems are a class of computerized information systems that support business or organizational decision-making activities. They are designed to assist managers and professionals in making informed decisions by providing relevant data, analytical tools, and models. These systems integrate various forms of data from internal and external sources, process the data using sophisticated algorithms, and present the results in a user-friendly format to facilitate effective decision-making.

Traditional decision support systems have been primarily focused on structured data and routine decisions, often failing to address the complexities and uncertainties inherent in modern business scenarios. As businesses evolve, there is a growing need for advanced DSS that can handle unstructured data, incorporate machine learning and artificial intelligence, and provide real-time insights. These enhanced systems are capable of analyzing vast amounts of data, recognizing patterns, predicting future trends, and offering actionable recommendations. Such capabilities are helpful for organizations to maintain a competitive edge, optimize operations, and drive strategic initiatives.

Despite the advancements in DSS technologies, there remain several challenges and limitations that need to be addressed. Current systems often struggle with data integration from diverse sources, real-time data processing, and user interface design that caters to the varying needs of different decision-makers. Furthermore, the complexity of implementing and maintaining these systems can be a significant barrier for many organizations. There is a need for innovative solutions that simplify the deployment and use of decision support systems, enhance their analytical capabilities, and improve their overall effectiveness in supporting business and organizational decision-making activities.

### SUMMARY

Described herein are embodiments (e.g., a method, a system, non-transitory computer-readable medium storing code or instructions executable by one or more processors) pertaining to a RECA&DE that enhances the capabilities of enterprise applications, transforming them from transactional/operational support systems into decision support systems.

In various embodiments, a computer implemented method is provided for that includes generating, by a data processing system, a first graphical user interface for implementing a decision support module within an enterprise application, where the first graphical user interface comprises one or more tools configured to allow a user to configure a discussion event; obtaining, by the data processing system, data for the discussion event from one or more sources within the enterprise application based on input from the user received via the first graphical user interface; receiving, by the data processing system, decision support input from the user via the first graphical user interface, where the decision support input comprises a request to create the discussion event based on the data for the discussion event obtained from the one or more sources, and where the request defines participants to contribute to the discussion event, determinants, which are attributes that the discussion event is centered around, and weights for the participants, determinants, or both; transferring, by the data processing system, event data to a discussion service, where the event data comprises the participants to contribute to the discussion event and the determinants; receiving, by the data processing system, feedback data from an artificial-intelligence platform, where the feedback data comprises sentiment data derived by the artificial-intelligence platform based on transcript data generated from conversations of the participants using the discussion service, and where the transcript data comprises textual feedback of the participants on the determinants; analyzing, by the data processing system, the feedback data based on the participants, the determinants, and the weights for the participants, determinants, or both defined for the discussion event; and rendering, by the data processing system, one or more dashboards in a second graphical user interface based on analyzing of the feedback data, where the one or more dashboards visualize sentiment of the participants for each determinant based on sentiment only, participant weightage, determinant weightage, or any combination thereof.

In some embodiments, the data for the discussion event from the one or more sources comprises a list of possible determinants. a list of possible participants, and information concerning each of the participants in the list of possible participants, and where the data for the discussion event from the one or more sources is obtained using an Extract, Transform, Load (ETL) process, APIs, real-time streaming services, or any combination thereof, such that the data is consolidated from the one or more sources into a centralized data warehouse, ensuring data consistency and quality.

In some embodiments, the feedback data comprises the sentiment data, quantitative or definite feedback, or both from each of the participants.

In some embodiments, the artificial-intelligence platform comprises one or more machine learning models trained for sentiment analysis of the transcript data, where the sentiment analysis comprises assigning sentiment scores to descriptive comments in the transcript data, and the sentiment data comprises the sentiment scores assigned to the descriptive comments, sentiment scores derived from the quantitative or definite feedback, or both.

In some embodiments, analyzing the sentiment data comprises: accessing information for the participants including weights for the participants, information for the determinants including the weights for the determinants, and the sentiment scores assigned to the descriptive comments, sentiment scores derived from the quantitative or definite feedback, or both; and aggregating sentiment value by determinant based on the sentiment scores assigned to the descriptive comments, sentiment scores derived from the quantitative or definite feedback, or both,

In some embodiments, analyzing the sentiment data comprises: accessing information for the participants including weights for the participants, information for the determinants including the weights for the determinants, and the sentiment scores assigned to the descriptive comments, sentiment scores derived from the quantitative or definite feedback, or both; and determining a participant sentiment score for each determinant based on the weights for the participants and the sentiment scores assigned to the descriptive comments, sentiment scores derived from the quantitative or definite feedback, or both.

In some embodiments, analyzing the sentiment data comprises: accessing information for the participants including weights for the participants, information for the determinants including the weights for the determinants, and the sentiment scores assigned to the descriptive comments, sentiment scores derived from the quantitative or definite feedback, or both; and determining a determinant score for each determinant based on the weights for the determinants and the sentiment scores assigned to the descriptive comments, sentiment scores derived from the quantitative or definite feedback, or both

Some embodiments include a system including one or more processors and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is an illustration of the building blocks of the RECA&DE in accordance with various embodiments.

FIG. 2 shows a block diagram illustrating the RECA&DE architecture in accordance with various embodiments.

FIG. 3A depicts a table illustrating overall sentiment for each determinant in accordance with various embodiments.

FIG. 3B depicts a table illustrating participant-wise classification of sentiment in accordance with various embodiments.

FIG. 3C depicts a table illustrating an effective derived sentiment for each determinant from each participant in accordance with various embodiments.

FIG. 4 illustrates a schematic diagram of deliberation and assertions in accordance with various embodiments.

FIG. 5 depicts a graph illustrating decision indicator based on team sentiment only in accordance with various embodiments.

FIG. 6 depicts a graph illustrating decision indicator after incorporating participant weights in accordance with various embodiments.

FIG. 7 depicts a graph illustrating decision indicator after incorporating determinant weights in accordance with various embodiments.

FIG. 8 depicts a graph illustrating decision indicator based on team sentiment and decision indicator after incorporating participant and determinant weights in accordance with various embodiments.

FIG. 9 show a block diagram illustrating an AI platform for training and deploying models in accordance with various embodiments.

FIG. 10 depicts a flowchart illustrating a decision support process in accordance with various embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

### Summary Real-Time Enterprise Conversation Analyzer and Decision Enabler (RECA&DE)

Organizations engage in collaborative discussions on a wide array of topics to reach collective and inclusive decisions. These discussions involve various stakeholders who possess differing levels of decision-making authority and expertise. While enterprise application software is rich in data and primarily serves operational purposes, it often lacks the necessary decision support capabilities due to the absence of a focused framework. The embodiments described herein proved for a comprehensive framework, infrastructure, and algorithm that enhance the capabilities of enterprise applications, transforming them from mere transactional/operational support systems into robust decision support systems.

The RECA&DE is configured to derive insights and enable informed decision-making based on extensive discussion transcripts within an organization using enterprise applications. The innovation employs a holistic approach that incorporates several elements. Firstly, an enterprise application framework is established for defining and overseeing discussion events. This framework utilizes the information, definitions, security, and controls accessible within the enterprise applications. Secondly, the invention integrates with a discussion forum service application, ensuring seamless communication. Thirdly, AI/ML-powered processing of discussion transcripts and quantitative feedback is employed to analyze and interpret the data. Furthermore, a deliberation algorithm is implemented to guide the decision-making process. Lastly, multi-dimensional reporting is used to provide comprehensive analysis and reporting of the discussion outcomes.

### Challenges Solved

Organizations aim for effective outcomes from various discussions that occur within and across their organizations. However, they often encounter several challenges that hinder effectiveness:
1. Lack of Information Technology Support: Enterprise applications commonly used by organizations often lack the capability to provide decision-enabling insights based on discussion transcripts. Information such as participant roles, job levels, organizational reporting hierarchy, experience, and expertise significantly impact discussions and subsequent decisions. Without the solutions disclosed, herein organizations cannot leverage this information effectively, leading to suboptimal decisions.
2. Lack of Inclusivity and Bias: Not all voices receive due consideration, leading to the omission of key arguments or feedback. Hierarchical levels of authority can result in undue compliance and bias during live discussions, skewing the outcomes.
3. Lack of Focus and Decision Clarity: Many discussions lack focus, resulting in wasted time and a lack of clear direction. Analyzing discussions objectively can be challenging, making it difficult to determine the appropriate course of action.
4. Lack of Real-time Status Updates: Real-time analysis of discussions is important for making informed decisions promptly. The absence of such real-time updates often results in time wastage and delays in decision-making.
5. Time Management: Discussions can be time-consuming for all participants, regardless of their ability or willingness to contribute. Poor time management and varying time zones exacerbate this issue, leading to inefficiencies.
6. Communication Barriers: Effective participation in live discussions can be hindered by communication shortcomings and time zone differences, limiting collaboration and understanding.

### Overview of Embodiments and Solution for Challenges

Embodiments described herein for a RECA&DE framework addresses the aforementioned challenges and others by enhancing the capabilities of enterprise applications, transforming them from mere transactional/operational support systems into decision support systems. More specifically, the RECA&DE framework is configured for managing and analyzing discussion events within enterprise applications, particularly in contexts such as software development projects. The framework leverages existing enterprise data, including roles, hierarchies, and job levels, to streamline the flow of discussions and ensure that every participant's feedback is appropriately weighted and considered. A primary objective of the embodiments is to provide a decision support dashboard that aids discussion initiators in making informed decisions based on comprehensive feedback analysis.

Initially, the framework defines a discussion event within the enterprise application by specifying the title, description, and determinants of the discussion. Determinants, such as cost, feasibility, and time to market, are key factors that influence the discussion's outcomes. Each determinant is assigned a weight based on its relative importance to the specific project or feature being discussed. For instance, in a given product or service feature offered by an enterprise, feasibility might be assigned a higher weight than cost, reflecting its greater significance in the decision-making process

Participants are invited to the discussion based on their roles, hierarchies, or job levels within the enterprise. This ensures that relevant stakeholders contribute their expertise and perspectives. For example, feedback from a vice president or a subject matter expert may be given higher weight compared to that from a junior employee. This weighted feedback mechanism can ensure that the opinions of more experienced or strategically positioned participants are considered more heavily in the decision-making process.

The framework supports multiple types of feedback, including descriptive text and definitive feedback such as star ratings or agree/disagree options. Descriptive text allows participants to provide detailed comments, while definitive feedback offers a quantifiable measure of their sentiments. Sentiment analysis is performed on both types of feedback using AI algorithms. The AI system processes the text feedback to determine sentiments (e.g., positive, neutral, negative) and maps these sentiments to corresponding definitive feedback ratings (e.g., five stars for very positive).

Once the feedback is collected, it is processed by a deliberation algorithm that integrates the weighted sentiments of participants and determinants. The algorithm calculates scores for each determinant based on the collected sentiments and their assigned weights. The output is a decision support dashboard that provides a comprehensive view of the discussion outcomes. The dashboard displays various metrics, including raw sentiment scores, participant-weighted sentiment scores, and a combination of participant and determinant-weighted scores. This multi-dimensional analysis enables discussion initiators to understand the overall sentiment, the influence of key participants, and the impact of different determinants on the discussion.

In some instances, the framework incorporates third-party or opensource discussion services to facilitate the logging and management of discussion threads. These services allow participants to register their feedback and discussions in an integrated platform, which is then fed back into the enterprise application for further processing by the AI and deliberation algorithms. This approach leverages existing tools and technologies, reducing the need for custom development of such platforms within the enterprise application.

Accordingly, the embodiments provide for a robust and flexible framework for managing enterprise discussions, ensuring that all feedback is appropriately weighted and analyzed to support informed decision-making. By leveraging existing enterprise data and integrating advanced AI sentiment analysis, the framework enhances the effectiveness and inclusiveness of organizational discussions.

Key aspects of the RECA&DE frame work include without limitation:
1. Focused Discussion: RECA&DE ensures focused discussions by leveraging enterprise application data. This includes limiting participants by role, job level, reporting hierarchy, experience, and expertise. Discussions are structured around defined determinants, and specific weightages are assigned for deliberation. This structured approach results in high-quality, relevant content crucial for informed decision-making.
2. Real-time Decision Support: By leveraging enterprise applications, discussion services, AI platforms, and a deliberation algorithm, RECA&DE provides real-time insights and assertions based on ongoing discussions. This capability enables prompt decisions on whether to iterate further or conclude the discussion.
3. Time Management: The focused discussion approach facilitated by RECA&DE contributes to better time management. Real-time analysis and reporting of conversation inferences empower discussion initiators to make informed decisions, thus ending discussions at the right time and saving valuable time.
4. Allowed Bias: The RECA&DE accommodates intended or allowed bias through carefully defined participant weights, ensuring fairness and accuracy in the decision-making processes.
5. Safety and Security: By effectively utilizing enterprise application data and framework, RECA&DE ensures implicit access and security of discussions, enhancing the credibility of reported outcomes.
6. Off-line Mode: RECA&DE promotes offline discussions to encourage active participation and reduce bias and undue compliance. The offline mode also addresses time zone issues, facilitating seamless collaboration across diverse geographical locations. Overall, RECA&DE streamlines discussions, enhances decision-making processes, promotes fairness, and ensures the security and credibility of outcomes, making it a valuable tool for organizational effectiveness.

Overall, the RECA&DE streamlines discussions, enhances decision-making processes, promotes fairness, and ensures the security and credibility of outcomes, making it a valuable tool for organizational effectiveness. More specifically, RECA&DE leverages enterprise application data for meaningful discussions and effective decision outcomes by optimally utilizing information such as participants' roles, experience, job level, organizational hierarchy, and department. It gives precise attention to discussion attributes and determinants, ensuring relevance and depth in deliberations. The RECA&DE allows for the adaptive adjustment of discussion weightages based on organizational roles and hierarchy as defined in the enterprise application, facilitating agile decision-making. The framework ensures equitable representation of every participant's input by assigning appropriate weightage, promoting inclusivity and fairness. Additionally, the framework provides real-time reports and insights, enabling swift conclusions, refinements, or redirection of discussions. The decision enabler offers comprehensive analysis through reports based on various dimensions such as sentiments and the impact of added participant weightage.

In various embodiments, a computer-implemented method is provided for facilitating decision-making within an enterprise application through a data processing system. The method involves generating a graphical user interface (GUI) that allows users to configure discussion events. Data for the discussion event is obtained from various sources within the enterprise application based on user input. Users provide decision support input to create the discussion event, specifying participants, determinants (attributes central to the discussion), and weights for these elements. Event data, including participants and determinants, is transferred to a discussion service. Feedback data, including sentiment data derived from participant conversations, is received from an AI platform. This feedback is analyzed based on participants, determinants, and their weights, and the results are visualized in dashboards on a second GUI, showing the sentiment related to each determinant.

### Overview of RECA&DE

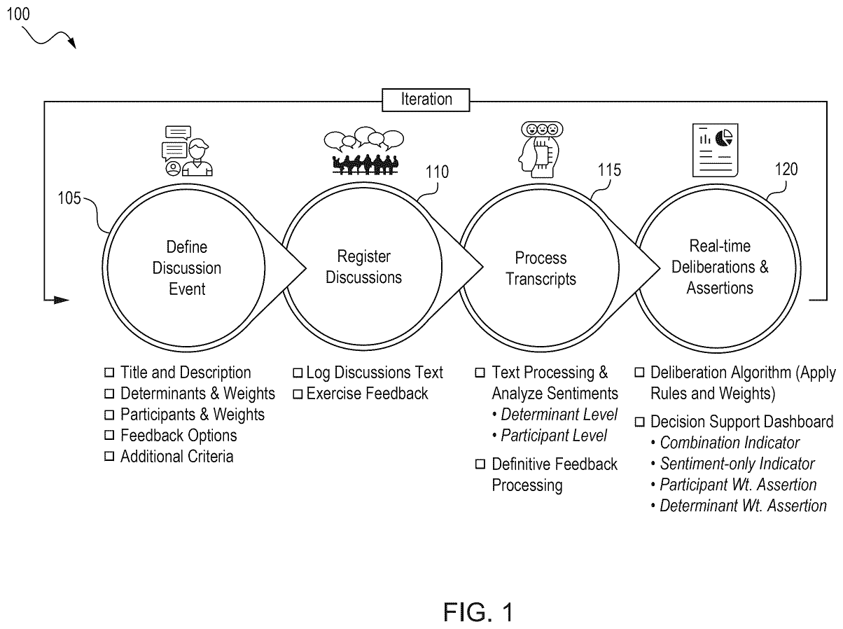

As shown in FIG. 1, the RECA&DE framework 100 includes four stages. In the first stage 105, a discussion event is defined within an enterprise application such as an Enterprise Resource Planning (ERP) (e.g., the Oracle Cloud Enterprise Resource Planning offered by Applicant, which is a cloud-based ERP software application that manages enterprise functions including accounting, financial management, project management, and procurement). A discussion event may be any topic, for example, a software development project, on which a user (e.g., a discussion initiator such as a project manager) wants to initiate a discussion with participants. In the second stage 110, discussions are registered and facilitated using a third-party or opensource discussion forum service and/or a discussion forum service available within the enterprise application. The discussion registration includes participants engaging in discussion and registering their quantitative/definitive feedback for the discussion event. In the third stage 115, a meaning is extracted out of the text transcript and quantitative/definitive feedback from the discussion on the discussion forum. The meaning may be the sentiment of the participants towards aspects or determinants for the discussion event and may be extracted using sentiment analysis via one or more machine learning models. In the fourth stage 120, one or more algorithms apply predefined rules and weightages from the enterprise applications to process the meaning extracted from the text transcripts and quantitative/definitive feedback from the discussion to generate multiple decision indicators. The multiple decision indicators are then consolidated into a single visualization, providing detailed information concerning the discussion event.

### Architecture of RECA&DE

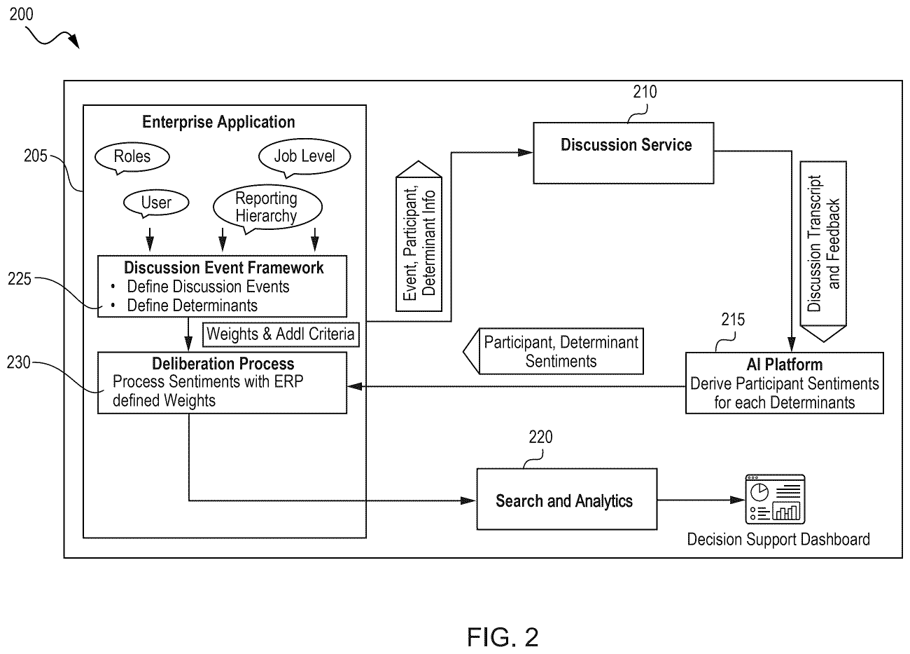

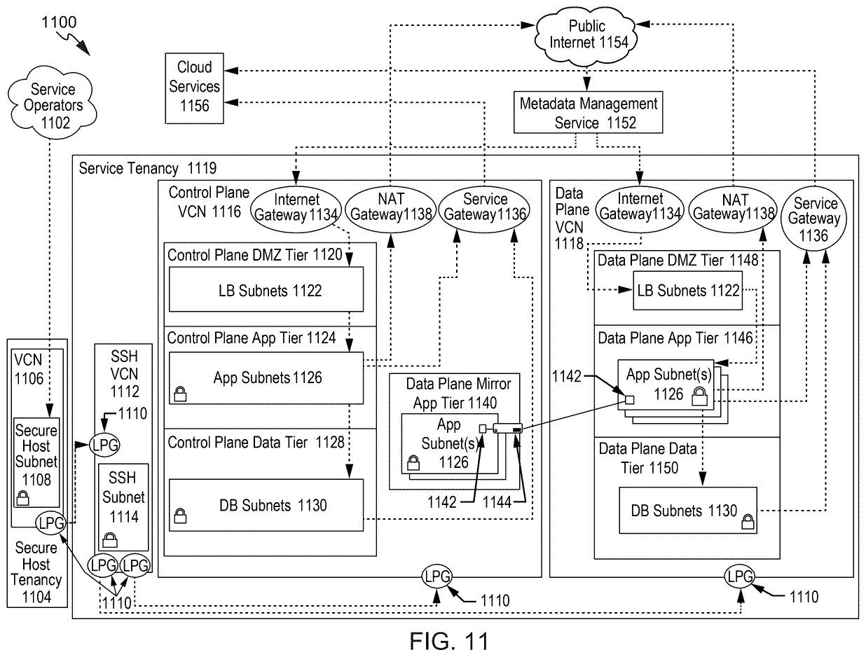

As shown in FIG. 2, the RECA&DE architecture 200 includes enterprise application 205, discussion service 210, AI platform 215, and analytics and visualization platform 220. The enterprise application 205 is a large-scale software solution designed to streamline and automate various processes of an organization's operation (i.e., helps enterprises (organizations, companies, and the like) run daily operations more efficiently). The enterprise application 205 may be offered or provisioned as a cloud-based application, which is a web-based application that functions in the cloud. These applications can be accessed from anywhere, and at any time, over the web. Examples of cloud applications are Google, Salesforce, and Dropbox. In the cloud provided by a cloud service provider, a user can find a broad range of software as a service (SaaS), platform as a service (PaaS), and infrastructure as a service (IaaS) applications including enterprise applications, as described in greater detail herein with respect to FIGS. 11-15). A user (e.g., a discussion initiator such as a project manager) can use these applications as part of a subscription-based service; there's no software license or hardware to buy and manage; instead, the cloud service provider handles all the supporting underlying technologies. The enterprise application 205 utilizes a software appliance (e.g., App Gateway) that enables a user to integrate applications hosted either on a compute instance, in a cloud infrastructure, or in an on-premises server with an identity cloud service for authentication and authorization purposes. This enables various users across the enterprise to access and utilize the enterprise application 205

An example of an enterprise application 205 is an Enterprise Resource Planning (ERP) application. ERP refers to a type of software that organizations use to manage day-to-day business activities such as accounting, procurement, project management, risk management and compliance, and supply chain operations (e.g., the Oracle Cloud Enterprise Resource Planning offered by Applicant, which is a cloud-based ERP software application that manages enterprise functions including accounting, financial management, project management, and procurement). A complete ERP suite also includes enterprise performance management, software that helps plan, budget, predict, and report on an organization's financial results. ERP systems tie together a multitude of business processes and enable the flow of data between them. By collecting an organization's shared transactional data from multiple sources, ERP systems eliminate data duplication and provide data integrity with a single source of truth. Nonetheless, as discussed herein, conventional enterprise applications including ERPs do not include decision support systems.

In order to address this challenge and others, the enterprise application 205 is supplemented with a RECA&DE (decision support module) comprising the discussion event framework 225 and deliberation engine 230. Supplementing the enterprise application 205 with the RECA&DE decision support module significantly enhances the functionality and effectiveness of the enterprise application 205 in several ways. First and foremost, the RECA&DE can provide advanced data analytics capabilities that help in making informed decisions. By analyzing vast amounts of data from various sources within the enterprise application including various users of the enterprise application, the RECA&DE can identify trends, patterns, and anomalies that might not be apparent through traditional reporting tools. Secondly, the RECA&DE can enhance the decision-making process by providing real-time insights and recommendations. Traditional enterprise applications often rely on historical data and periodic reporting, which may not be sufficient for dynamic business environments. The RECA&DE, on the other hand, can process real-time data and provide immediate feedback to decision-makers such as a discussion initiator. Lastly, integrating the RECA&DE with an enterprise application can improve user experience and adoption by offering intuitive and user-friendly interfaces for data analysis and decision-making. The RECA&DE can present complex data in easily understandable formats, such as interactive dashboards, visualizations, and reports. This accessibility empowers users at all levels of the organization to leverage data insights without requiring advanced technical skills. Additionally, the RECA&DE can be customized to meet the specific needs and preferences of different user groups, ensuring that the insights and recommendations provided are relevant and actionable. By enhancing the usability and relevance of data-driven insights, the RECA&DE can drive higher engagement and adoption among users, ultimately leading to better decision-making and improved business outcomes.

Nonetheless, implementing the RECA&DE within the enterprise application 205, such as an ERP system, involves several technical challenges including overcoming significant data integration and management challenges. One primary issue is the existence of data silos, where critical information is isolated within different modules or external sources, making it difficult to obtain a comprehensive view necessary for informed decision-making. To address this, the IaaS system upon which the enterprise application 205 runs includes a data integration platform or middleware that facilitates seamless data exchange between disparate systems. For example, using an Extract, Transform, Load (ETL) process, APIs, real-time streaming services, or any combination thereof, data can be consolidated from various sources into a centralized data warehouse, ensuring data consistency and quality. Additionally, a real-time data processing framework, such as Apache Kafka or AWS Kinesis, can be implemented to enable timely updates and insights, enhancing the decision support system's responsiveness and relevance.

Another significant challenge is ensuring the RECA&DE can integrate seamlessly with existing modules within the enterprise application 205 and other enterprise applications. This is accomplished via a robust API management and interoperability solution that includes utilizing standardized APIs that facilitate smooth communication between the RECA&DE and other systems, ensuring data flows efficiently and accurately. For legacy systems that may lack modern interfaces, adopting middleware solutions that can bridge the gap between old and new technologies can be effective. For instance, using integration platforms like MuleSoft or Dell Boomi can help connect legacy systems with modern cloud-based applications, ensuring comprehensive data integration and functionality across the enterprise.

Lastly, security and compliance are also significant challenges in implementing a cloud-based decision support system. Protecting sensitive data from unauthorized access and ensuring compliance with regulations like GDPR, HIPAA, or SOX is paramount. To address these concerns, a strong encryption protocol for data at rest and in transit, multi-factor authentication, and granular access controls that restrict data access based on user roles and responsibilities may be implemented (e.g., via an identity cloud service). Regular security audits and compliance checks may be used to identify and mitigate potential vulnerabilities. Additionally, leveraging a cloud providers' built-in security features, such as Oracle Cloud Infrastructure (OCI) Security, can be used to enhance the security posture of the RECA&DE, ensuring that sensitive data remains protected and compliant with relevant regulations.

Moreover, integrating the enterprise application 205 supplemented with the RECA&DE with additional systems and services such as discussion service 210, the AI platform 215, and the analytics and visualization platform 220 involves several additional technical challenges including ensuring seamless integration and interoperability between the RECA&DE and these external systems and services. This requires robust API management and the ability to handle various data formats and protocols used by third-party services. Additionally, managing data latency and ensuring real-time data synchronization can be complex, especially when relying on external data sources. Security and compliance are also heightened concerns, as data must be securely transmitted and stored, adhering to regulatory standards across different jurisdictions. Furthermore, dependency on third-party services introduces risks related to service reliability and availability, necessitating comprehensive monitoring, fallback mechanisms, and service-level agreements (SLAs) to ensure the RECA&DE remains functional and reliable.

To address these challenges, a combination of advanced integration technologies, rigorous security measures, and strategic partnerships with reliable third-party service providers is implemented. These technologies include an API management platform, which facilitates the development, deployment, and maintenance of APIs that enable data exchange between the RECA&DE and external systems. Tools such as MuleSoft, Apigee, and Microsoft Azure API Management provide robust capabilities for handling various data formats, ensuring secure and efficient communication, and managing API lifecycles. Additionally, integration middleware solutions, like Dell Boomi and IBM App Connect, help bridge the gap between legacy systems and modern cloud-based applications, ensuring interoperability and data consistency. Real-time data integration tools, such as Apache Kafka and AWS Glue, enable continuous data streaming and real-time analytics, allowing the RECA&DE to process and analyze data as it arrives from third-party sources. These technologies, combined with advanced security measures like OAuth for secure authentication and encryption protocols for data protection, ensure that the RECA&DE can effectively and securely integrate with external systems, providing comprehensive and timely insights for decision-making.

Once the enterprise application 205 is supplemented with the RECA&DE and integrated with additional systems and services such as the discussion service 210, the AI platform 215, and the analytics and visualization platform 220, the enterprise application 205 is ready to be deployed and used for decision support (realizing the benefits of integrating all these technologies into a single framework). As shown in FIG. 2, initially, the discussion event framework 225 is used to predefine determinants for the RECA&DA. Determinants are a set of decision-centric attributes. These attributes are the key factors that discussions are centered around, ultimately guiding the decision-making process. Consequently, the discussion event framework 225 is initially used to perform a one-time master setup via determinant code and description to predefine a list of determinants that would be most appropriate for decision support and discussion of operations being performed via the enterprise application 205. As should be understood the determinants predefined at this stage should have applicability across a wide array of discussion events applicable for the enterprise application 205.

Thereafter, the discussion event framework 225 may be used by one or more users (e.g., a discussion initiator such as a project manager) to define one or more discussion events to be handled by the RECA&DA. Defining a discussion event includes defining a title of the discussion (e.g., New UI Wireframe Review) and description (e.g., purpose and objective of discussion as detailed text) for the discussion event. For example, the user defining the discussion event may answer one or more of the following questions via a user interface within the enterprise application 205 to define the discussion event: (i) What is the title for the discussion event? (ii) What is the topic of the discussion? (iii) What is the purpose of the discussion? (iv) What is the expected outcome of the discussion? (v) What are the participants expected to contribute or achieve during the discussion? The above information will help the participants to understand and contribute effectively during the discussion event.

The discussion event framework 225 may then be used to select participants for the discussion event to further define the discussion event (participants would be attainable or available via the enterprise application). Participants are individuals identified and assigned by the user and are those who are expected to engage in the discussion. They may be determined using enterprise-defined data within the enterprise application 205, which includes information such as job roles, departments, reporting hierarchy, and other relevant organizational structures. This data may be, for example, available with the ERP system Definitions. These participants are selected based on their expertise, responsibilities, and relevance to the topic of discussion, ensuring an effective and meaningful conversation (e.g., a specific role, a specific organization, a specific skill level, a specific job level, etc.) For example, an internal discussion regarding the procurement of a service from a service provider could involve participants from departments such as Production, Procurement, Logistics, and Finance. Additional participants may be invited based on their position within the hierarchy or if they hold higher job roles within the selected departments (e.g., Vice Presidents, Contract Administrators etc.,).

An exemplary process of selecting participants using a user interface that interfaces with the enterprise application 205 (e.g., ERP) is described below:

### (Drop-Down List Values Role, Job Role, Hierarchy, User)

i. Select ‘Role’ to select one or more users belonging to the one or more selected roles as associated in ERP (e.g., UX Designer)
ii. Select ‘Hierarchy’ to select a user and additionally include users within a ERP hierarchy (Possible values: Above/Below/Both).
iii. Select ‘Job Level’ to invite one or more users in one or more job levels (e.g., Individual Contributor 5 (IC5))
iv. Select ‘User’ to Individually pick participants from the list of users in the ERP.

The user can then optionally assign weightages via discussion event framework 225 to participants, which then play an important role in the deliberation algorithm implemented via deliberation engine 230. This algorithm uses these defined weights to generate decision support data. Consequently, the feedback or responses from participants with higher weightages carry more influence in the final decision outcome. Participants may receive higher weightages based on factors such as their organizational position, decision-making authority, and subject matter expertise. This ensures that their contributions have a substantial impact on the ultimate outcome. For example, in a scenario with 10 participants (Participant_1, Participant_2 . . . . Participant_10), the discussion initiator may assign higher weightages to Participant_4 and Participant_5 to amplify the significance of their input in shaping the final decision.

An exemplary process of assign weightages to participants using a user interface that interfaces with the enterprise application 205 (e.g., ERP) is described below:
Selected participants could be assigned with weights that deliberation engine 230 consider suggesting decision outcomes.
For example, option to:
   1. Distribute weights equally (Default Option)
   2. Assign weights (By User, By Role, By Hierarchy).
User Level weights can be set to override the Hierarchy, and the Hierarchy can be set to override Roles.

The discussion event framework 225 is then used to identify: (i) appropriate determinants for the discussion event from the predefined list of determinants and (ii) weights for the determinants. As discussed above, determinants are a set of decision-centric attributes. These attributes are the key factors that discussions are centered around, ultimately guiding the decision-making process. For example, the determinants for a software development project may include cost, feasibility, complexity, time to market, design appropriateness, maintenance, and the like. These are the various attributes (i.e., determinants) that the discussion event will focus upon once initiated. Further, the attributes may be assigned with weights, i.e., the same weights (Default: Equal Weight) or different weightages (e.g., 50 for feasibility, 30 for cost, 10 for complexity, and 10 for maintenance). The sum of weightage of all determinants should be equal to 100. For example, in certain crucial projects, the determinant ‘Feasibility’ may carry greater significance (Weightage) than ‘Cost.’ As a result, ‘Feasibility’ may be assigned a more pronounced impact on the decision outcome compared to ‘Cost’. However, ‘Cost’ may remain one of the factors influencing the decision limited to the weightage defined for the same.

The discussion event framework 225 may then optionally be used by the user to specify feedback options for participants. Feedback could be either descriptive comments or quantitative/definite feedback. Descriptive comments are textual feedback provided by participants. These comments will undergo additional processing by the AI platform 215 to extract sentiments related to the defined determinants by the enterprise, as further described in detail herein. Quantitative/definitive feedback comprises assertive and definite responses from participants, such as Upvotes/Downvotes, Likes/Dislikes, Star Rating (1-5 Stars), and the like.

An exemplary process of specifying feedback options for participants using a user interface that interfaces with the enterprise application 205 (e.g., ERP) is described below:
Select one or more Quantitative/definitive Feedback options.
   i. Upvotes/Downvotes (Upvote—Positive/Downvote—Negative)
   ii. Likes/Dislikes (Like—Positive/Dislike—Negative)
   iii. Star Rating (1-5 Stars)—(1—Very Negative, 2—Negative, 3—Neutral, 4—Positive, 5—Very Positive)

Lastly, the discussion event framework 225 may then be used by the user to review the entered information for the event and submit the discussion event to initiate the transfer of event data to a discussion service 210 for hosting the discussion event.

The discussion service 210 can either be part of the enterprise application 205 or a third-party (e.g., opensource discussion) service (i.e., discussion/blogging services). In the instance where the discussion service 210 is a third-party discussion service, an interface program is used to integrate the discussion service 210 with the enterprise application 205. For example, the interface program can stage or register a participants list (Event ID, User ID, Username from ERP) and determinants list for the event (Event ID, Determinant ID, Description) with the discussion service 210. In either instance, the discussion service 210 is an online space designed to facilitate conversations among participants about specific topics (e.g., the defined discussion event). The forum is comprised of various threads or topics where users can post messages, questions, or comments. Each discussion thread is organized chronologically, with the original post at the top, followed by responses. Participants or users can reply to the original post or to other responses within the thread, creating a nested or flat structure of conversation. The discussion service 210 may categorize these threads into different sections or sub-forums based on themes or subjects, making it easier for users to navigate and find discussions relevant to their interests.

Transcripts of conversations on the discussion service 210 are generated through a systematic process involving the discussion service's software and database management. When a user posts a message on the discussion service 210, the content of the post, along with associated metadata such as the username, timestamp, and any relevant tags or categories, is stored in a database. This storage process ensures that each post is preserved in its original form, allowing the entire conversation to be reconstructed later. Each interaction, whether it's a new post, a reply, or an edit, is recorded in this manner, creating a comprehensive log of the discussion. Users can typically edit or delete their posts within a certain time frame, but the discussion service 210 may keep a record of these changes to maintain the integrity of the discussion. Additionally, the discussion service 210 may have moderation tools that allow administrators or moderators to manage posts, remove inappropriate content, and enforce community guidelines.

Discussion service 210 further enables feedback on discussion topics to be provided through various mechanisms including textual (plain text) such as comments or replies and quantitative/definitive feedback such as upvotes, downvotes, likes, or reactions (e.g., as specified using the discussion event framework 225), which allow participants to express their opinions on the value or relevance of one or more discussion topics. Discussion service 210 may also enable users to leave feedback directly on individual posts, contributing to a more interactive discussion. The feedback system helps highlight valuable contributions and can influence the visibility or ranking of posts within a thread. In addition to storing the content of posts, the discussion service 210 may also log any feedback provided by participants, such as comments, replies, upvotes, downvotes, likes, or reactions. This feedback is also saved in the database alongside the corresponding posts, creating a detailed record of user engagement and sentiment. Overall, the generation of transcripts by the discussion service 210 involves capturing and organizing all user interactions and feedback in a structured and accessible manner, ensuring that the complete history of conversations is preserved for future reference.

Once the discussion service 210 captures a transcript of a conversation for the discussion event (e.g., after a predetermined period of time allotted or set for the discussion event), a transfer of the transcript is initiated to the AI platform 215 for further processing including sentiment analysis. Sentiment analysis, also known as opinion mining, is a technique in natural language processing (NLP) that involves identifying and categorizing the emotional tone expressed in textual data. It aims to determine whether the sentiment conveyed in the text is positive, negative, neutral, or falls into other more nuanced categories, such as very positive or very negative. This analysis may be performed using machine learning algorithms or lexicon-based approaches, which analyze the text for sentiment-bearing words and phrases. Sentiment analysis is used in various applications, including customer feedback analysis, social media monitoring, market research, and brand reputation management, as it provides valuable insights into public opinion and customer sentiments, helping businesses and organizations make informed decisions based on the emotional responses of their audience. In this particular instance, the sentiment analysis is performed by the AI platform 215, in order to derive the emotional tone of the participates expressed in the conversation for the discussion event based on the transcript of the conversation (i.e., the text in the transcript and quantitative/definitive feedback).

The processing by the AI platform 215 includes a series of processing tasks to prepare it for sentiment analysis and further insights. These tasks are performed for transforming raw conversation data into structured and meaningful information. Initially, the preprocessing of discussion transcripts may include eliminating stop words, which are common words such as “and,” “the,” “is,” etc., that do not contribute significantly to the meaning of the text in sentiment analysis. This step may be performed using a predefined list of stop words that is filtered out from the transcript. Additionally, special characters, including punctuation marks, symbols, and other non-alphabetic characters, may be removed to ensure the text is in a standardized format, facilitating subsequent analysis. This removal may be performed using regular expressions to systematically identify and eliminate these characters.

Next, the cleaned text may undergo tokenization, where the text is broken down into individual words or tokens. Tokenization is important for analyzing each word separately, which is useful in many text processing tasks, including sentiment analysis. Following tokenization, normalization may be performed, which includes converting all text to lowercase to ensure uniformity and reduce redundancy. Normalization may also involve stemming or lemmatization, which reduces words to their base or root form (e.g., “running” to “run”), treating different forms of a word as a single entity.

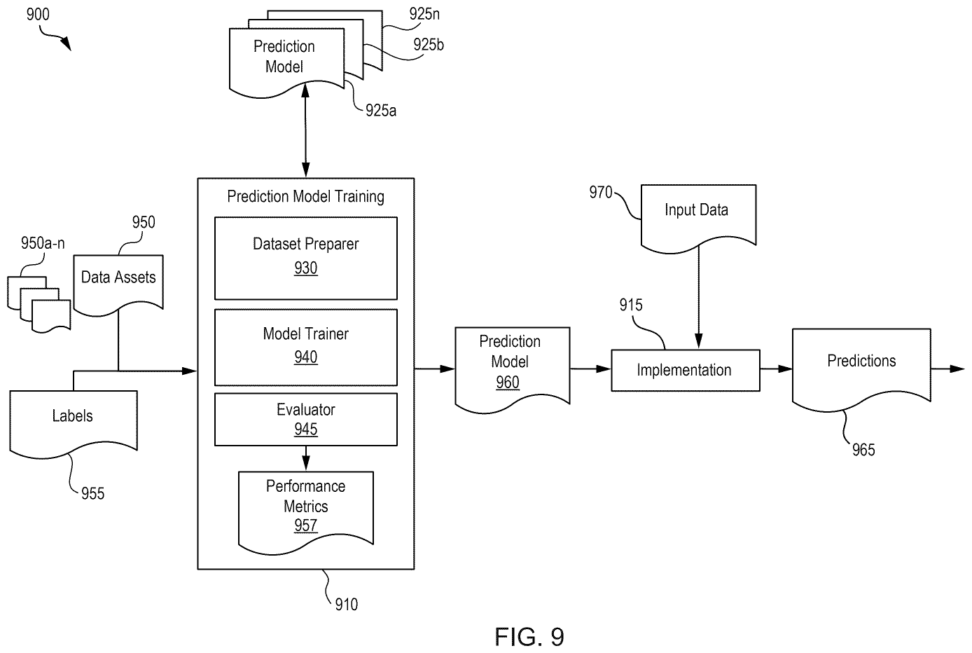

The next step involves utilizing an appropriate machine learning (ML) model for sentiment analysis (see discussion of FIG. 9 herein for a more in-depth description of the AI platform 215, which may be implemented via a ML service such as OCI DataScience). The selection of the ML model, although not the primary focus of this disclosure, is important and involves choosing from algorithms such as Naïve Bayes and Support Vector Machines (SVM) to advanced models like BERT (Bidirectional Encoder Representations from Transformers) and LSTM (Long Short-Term Memory) networks. The chosen model is trained on a labeled dataset containing examples of text and their corresponding sentiment labels. This training helps the model learn patterns and features that indicate different sentiments. The preprocessed transcript is fed into the model, which assigns sentiment scores to each piece of text, typically ranging from very negative to very positive, indicating the emotional tone of the conversation.

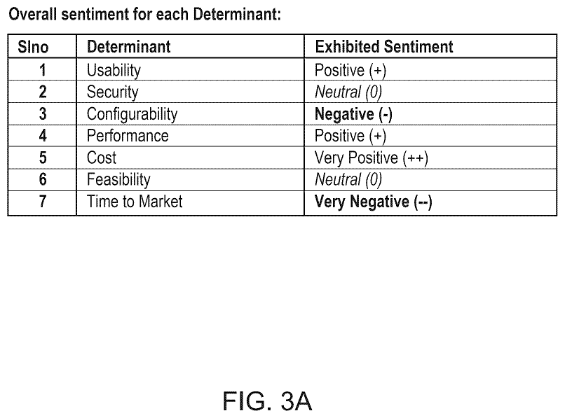

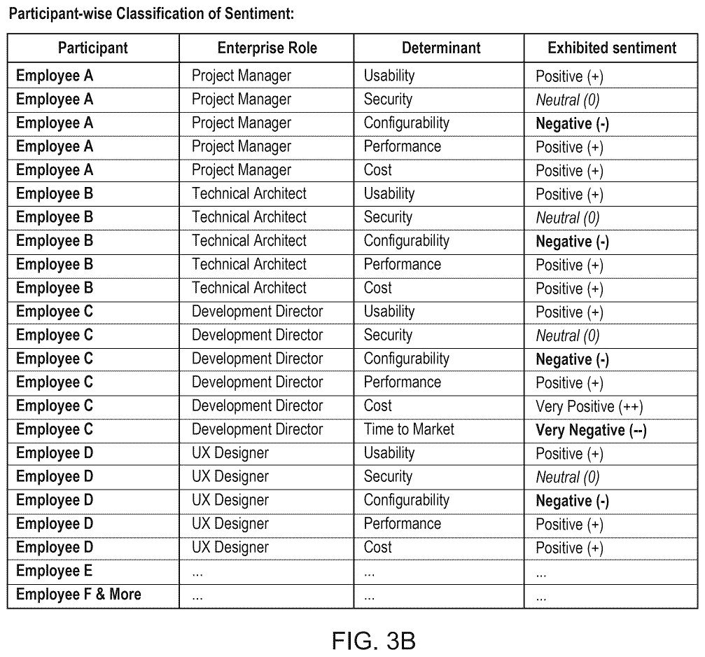

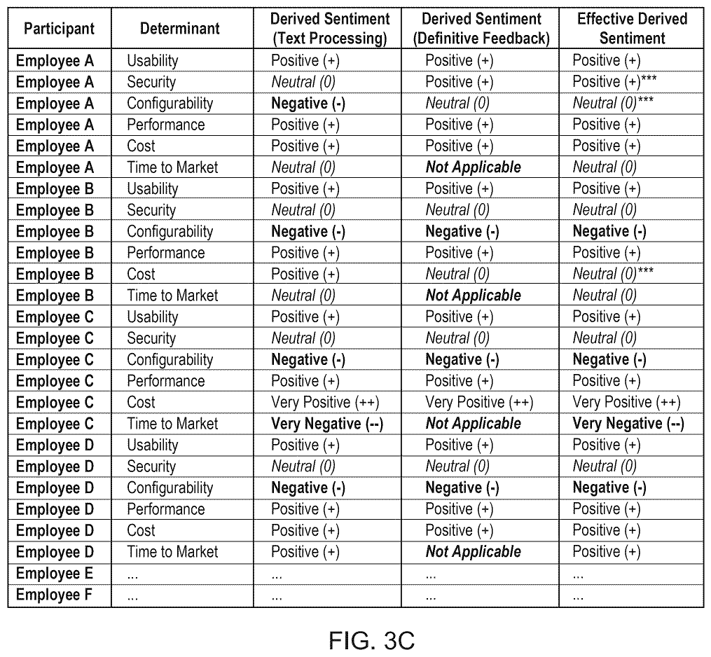

Following sentiment analysis, the process involves extracting text sentiments related to the determinants defined within the enterprise application 205. As previously discussed, determinants are specific aspects or themes relevant to the discussion event, such as product features, customer service, pricing, or other key factors that discussions are centered around, ultimately guiding the decision-making process. The first step in this task is to identify these determinants within the text. The transcript is then segmented into parts that correspond to these determinants, which may involve keyword matching or more sophisticated natural language processing (NLP) techniques to identify relevant sections of text. The sentiment analysis model is applied to these segmented parts to extract sentiment scores specifically related to each determinant, providing more granular insights than analyzing the text as a whole. The sentiments extracted for each determinant from the participants are aggregated to derive an overall sentiment score for each determinant, which can be done by averaging the sentiment scores or using more complex aggregation methods that account for the intensity and frequency of sentiments. As shown in FIG. 3A, the aggregated sentiment scores for each determinant are then classified into categories such as Very Positive, Positive, Neutral, Negative, and Very Negative. This classification provides a clear and concise summary of sentiment towards each determinant, making it easier to interpret the data and draw actionable insights.

The next task is deriving sentiments to depict the sentiment of each participant regarding each determinant. This process begins with identifying each participant in the conversation and aggregating their contributions to the discussion and each determinant. This involves tracking individual users and compiling all their posts or comments within the transcript. The sentiments extracted from each participant's contributions are aggregated to derive an overall sentiment score for each determinant, which can be done by averaging the sentiment scores or using more complex aggregation methods that account for the intensity and frequency of sentiments. As shown in FIG. 3B, the aggregated sentiment scores for each participant are then classified into categories such as Very Positive, Positive, Neutral, Negative, and Very Negative. This classification provides a clear and concise summary of each participant's sentiment towards each determinant, making it easier to interpret the data and draw actionable insights.

Participants' quantitative/definitive feedback hold greater weight in determining sentiments, as they are more definitive compared to sentiments derived from text processing. Therefore, quantitative/definitive feedback override text processing results in assessing sentiments.

Quantitative/definitive feedback may be processed by assigning equivalent sentiment attributes, for example, as follows:
1 Star—Very Negative
2 Star—Negative
3 Star—Neutral
4 Star—Positive
5 Star—Very Positive
   If the determinant within the discussion event framework 225 includes both definitive feedback and text-based input, but definitive feedback is unavailable, the sentiment derived through text processing will be used. However, if text feedback is either absent or inconclusive, and definitive feedback is also missing, the derived sentiment will default to ‘Neutral’ and be excluded from further processing. Upvotes, Downvotes, Likes, and Dislikes are binary in nature, therefore they may be categorized as either Positive or Negative sentiments as applicable. Similarly, if a participant does not provide feedback using this mode, it may not be considered for further processing, like star ratings. After incorporating the quantitative/definitive feedback into the discussion transcript, the resulting outcome appears as shown in FIG. 3C.

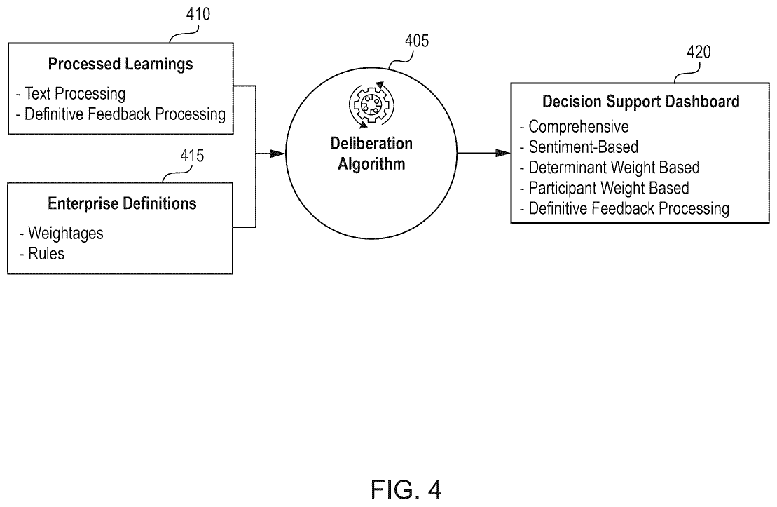

The deliberation engine 230 then retrieves (e.g., using a REST service) the following details (sentiment data) back from the AI platform 215, as shown in FIG. 3C, Participant, Determinant, Derived Sentiment (Text Processing), Derived Sentiment (Definitive Feedback), and Effective Derived Sentiment (Final). As shown in FIG. 4, the deliberation engine 230 uses a deliberation algorithm 405 to analyze both enterprise application data 410 (e.g., the defined weights and rules) and the sentiment data 415 (e.g., the text processing and definitive feedback processing) retrieved from the AI platform 215 and determines a score for each determinant, which can then be visualized in a decision support dashboard 420.

The process of deriving scores for each determinant based on enterprise application data and the sentiment data involves applying the predefined weights and rules for both participants and determinants. These weights may assist for accurately reflecting the importance and influence of various factors (e.g., importance of the opinion of one participant over another and/or the importance of one determinant over another) in the final score calculation. Follows is a step-by-step explanation of the deliberation algorithm 405 and how this may be accomplished:

1. Retrieving Sentiment Data: The deliberation engine 230 initially fetches sentiment data from the AI platform 215 via a REST service. This data comprises information for each participant, including the determinant being discussed, the sentiment inferred through text processing, and the corresponding definitive feedback. Table 1 below is a sample of the data retrieved through the REST service.

TABLE 1

| | | Sentiment | Multi | Sentiment | Normalized |
|---|---|---|---|---|---|
| Participant | Determinant | Value | Factor | Score | Score |
| A | Cost | 4 | 10 | 40 | 5.5000 |
| A | Security | 3 | 10 | 30 | 1.0000 |
| A | Usability | 5 | 10 | 50 | 10.0000 |
| B | Cost | 3 | 10 | 30 | 1.0000 |
| B | Security | 4 | 10 | 40 | 5.5000 |
| B | Usability | 3 | 10 | 30 | 1.0000 |
| C | Cost | 4 | 10 | 40 | 5.5000 |
| C | Security | 3 | 10 | 30 | 1.0000 |
| C | Usability | 5 | 10 | 50 | 10.0000 |

2. Aggregating Sentiment Value by Determinant: This aggregation process does not account for the participants expressing the sentiment or the importance of the determinant in influencing the decision outcome. Instead, it represents a zero-bias sentiment score for each determinant.
The Sentiment Score may be calculated as the average of sentiment values for each determinant, scaled by a multiplication factor to adjust the range without altering the distribution.
These sentiment scores may then be normalized to a scale of 0 to 10 to ensure seamless representation in charts. Normalized sentiment scores may be determined using the following formula (1):
Let:

$$SS = Sentinment Score$$

$$MN = Minimum Sentiment Score within the distribution$$

$$MX = Maximum Sentiment Score within the distribution$$

$$Normalized Sentiment Score ( NSS ) = 1 + ( SS - MN ) / ( MX - MN ) ) * 9 \qquad ( 1 )$$

This approach ensures consistency and clarity when visualizing sentiment data (see Table 2).

TABLE 2
Determinant Sentiment Assertion

| Determinant | Sentiment Score | Normalized Score |
|---|---|---|
| Cost | 36.6667 | 4 |
| Security | 33.3333 | 1 |
| Usability | 43.3333 | 10 |

3. Assigning Participant Weights: The Participant Sentiment Score for each determinant may be calculated as the product of the participant's weight and their sentiment value for that determinant. To better space out the scores without affecting the distribution, this value may be further scaled by a constant factor, e.g., a factor of 10.
The participant scores may be subsequently normalized to a range of 0 to 10 for seamless representation in charts. Normalized participant scores may be determined using the following formula (2):
Let:

$$PS = Participant Score$$

$$MN = Minimum Participant Score within the distribution$$

$$MX = Maximum Sentiment Score within the distribution$$

$$Normalized Participant Score ( NDS ) = 1 + ( ( PS - MN ) / ( MX - MN ) ) * 9 \qquad ( 2 )$$

This approach ensures consistent and intuitive visualization of participant sentiment contributions (see Table 3).

TABLE 3
Participant Weight Assertion

| | | Sentiment | Participant | Multiplication | Participant | Normalized |
|---|---|---|---|---|---|---|
| Participant | Determinant | Value | Weight | Factor | Score | Score |
| Participant A | Cost | 4 | 1.3 | 10 | 52 | 6.3438 |
| Participant A | Security | 3 | 1.3 | 10 | 39 | 2.6875 |
| Participant A | Usability | 5 | 1.3 | 10 | 65 | 10.0000 |
| Participant B | Cost | 3 | 1.6 | 10 | 48 | 5.2188 |
| Participant B | Security | 4 | 1.6 | 10 | 64 | 9.7188 |
| Participant B | Usability | 3 | 1.6 | 10 | 48 | 5.2188 |
| Paticipant C | Cost | 4 | 1.1 | 10 | 44 | 4.0938 |
| Paticipant C | Security | 3 | 1.1 | 10 | 33 | 1.0000 |
| Paticipant C | Usability | 5 | 1.1 | 10 | 55 | 7.1875 |

4. Assigning Determinant Weights: Each determinant (e.g., product feature, customer service, cost, etc.) may be assigned a weight that reflects its importance to the enterprise or the specific discussion event. These weights help prioritize which aspects of the feedback require deeper analysis and response.

5. Scoring Determinant based sentiments: The Determinant Score may be calculated for each determinant as the product of the Determinant's weight and their sentiment value for that determinant. To adjust the score range without affecting the distribution, the value may further be scaled by a constant factor, e.g., a factor of 10.
These scores may then be normalized to a scale of 0 to 10 for seamless representation in charts. Normalized determinant scores may be determined using the following formula (3):
Let:

$$DS = Determinant Score$$

$$MN = Minimum Determinant Score within the distribution$$

$$MX = Maximum Determinant Score within the distribution$$

$$Normalized Determinant Score ( NDS ) = 1 + ( ( DS - MN ) / ( MX - MN ) ) * 9 \qquad ( 3 )$$

This approach ensures consistent and intuitive visualization of determinant sentiment contributions (see Table 4).

TABLE 4
Determinant Weight Assertion

| | | Sentiment | Determinant | Multiplication | Determinant | Normalized |
|---|---|---|---|---|---|---|
| Participant | Determinant | Value | Weight | Factor | Score | Score |
| Participant A | Cost | 4 | 1.3 | 10 | 52 | 1.0000 |
| Participant A | Security | 3 | 1.3 | 10 | 39 | 2.6875 |
| Participant A | Usability | 5 | 1.3 | 10 | 65 | 10.0000 |
| Participant B | Cost | 3 | 1.6 | 10 | 48 | 5.2188 |
| Participant B | Security | 4 | 1.6 | 10 | 64 | 9.7188 |
| Participant B | Usability | 3 | 1.6 | 10 | 48 | 5.2188 |
| Paticipant C | Cost | 4 | 1.1 | 10 | 44 | 4.0938 |
| Paticipant C | Security | 3 | 1.1 | 10 | 33 | 1.0000 |
| Paticipant C | Usability | 5 | 1.1 | 10 | 55 | 7.1875 |

6. Arriving at Comprehensive score: The Comprehensive Score integrates both participant and determinant scores, providing a more robust decision-making indicator. This score accounts for who is expressing a sentiment, their influence in the decision-making process, and the relative importance of the determinant in the discussion outcome.
The Comprehensive Score (CS) may be determined using the following formula (4):
Let:

$$SV = Sentiment Value provided by a Participant for a Determinant$$

$$DW = Determinant Weight ( predefined )$$

$$PW = Participant Weight ( predefined )$$

$$MF = Muliplication Factor ( used to adjust score spacing )$$

$$Comprehensive Score ( CS ) = SV \times DW \times PW \times MF \qquad ( 4 )$$

This approach ensures a balanced and detailed evaluation by incorporating the significance of both participants and determinants into the final score (see Table 5).

TABLE 5
Comprehensive Score Assertion

| | | Sentiment | Determinant | Participant | Mult. | Comprehensive | Normalized |
|---|---|---|---|---|---|---|---|
| Participant | Determinant | Value | Weight | Weight | Factor | Score | Score |
| A | Cost | 4 | 1.1 | 1.3 | 10 | 57.2 | 6.1857 |
| A | Security | 3 | 1.8 | 1.3 | 10 | 54.0 | 5.5000 |
| A | Usability | 5 | 1.5 | 1.3 | 10 | 75.0 | 10.0000 |
| B | Cost | 3 | 1.1 | 1.6 | 10 | 33.0 | 1.0000 |
| B | Security | 4 | 1.8 | 1.6 | 10 | 72.0 | 9.3571 |
| B | Usability | 3 | 1.5 | 1.6 | 10 | 45.0 | 3.5714 |
| C | Cost | 4 | 1.1 | 1.1 | 10 | 44.0 | 3.3571 |
| C | Security | 3 | 1.8 | 1.1 | 10 | 54.0 | 5.5000 |
| C | Usability | 5 | 1.5 | 1.1 | 10 | 75.0 | 10.0000 |

7. Visualization in Decision Support Dashboard: Normalized scores for each assertion are the output of the Deliberation Algorithm. These scores are displayed as visualizations within the Decision Support Dashboard. These visual representations enable stakeholders to quickly grasp the sentiment landscape, identify critical areas, and focus on aspects requiring immediate attention.

8. Continuous Updating and Refinement: The deliberation engine 230 dynamically updates and refines weights and scoring rules based on new data and feedback. This iterative process ensures that the scoring model remains accurate, relevant, and aligned with evolving participant behaviours and changes in the significance of determinants.

9. Actionable Insights: The generated scores deliver actionable insights that guide strategic decision-making. For example, they can highlight the need to enhance a specific product feature or address customer service challenges. By leveraging weighted sentiment data, the enterprise can effectively prioritize actions with the potential for the most substantial positive impact.

Advantageously, through this process, the deliberation engine 230 effectively translates raw sentiment data into meaningful scores for each determinant, reflecting both the importance of the participants and the relevance of the determinants. This ensures that the enterprise can make informed decisions based on a nuanced understanding of sentiment trends.

As discussed above, output of the deliberation engine 230 and enterprise application data may then be transferred to a visualization platform 220 (e.g., OpenSearch) to visualize on a decision support dashboard using data visualization tools (e.g., Kibana). The visualization platform 220 is a scalable and flexible platform for search, logging, and analytics, enabling users to index, search, and analyze large volumes of data (e.g., the output of the deliberation engine 230 and enterprise application data) in real-time. The visualization platform 220 includes features such as full-text search, structured search, and analytics capabilities, and it is designed to be highly extensible with a rich ecosystem of plugins. It also offers a user-friendly interface through dashboards (e.g., decision support dashboards), which allows for the visualization and exploration of data. Follows is an explanation of some of the indicators and analytics that can be explored via visualization platform 220 in various dashboards using the output of the deliberation engine 230 and enterprise application data.

### Sentiment-Only Indicator Dashboard

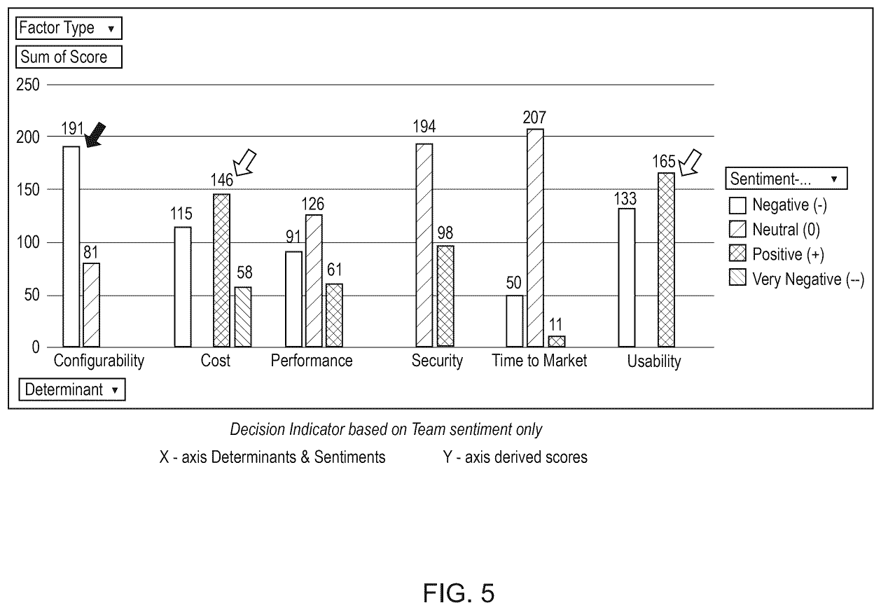

The sentiment-only indicator (sentiment scores attributed to each determinant) reflects the collective sentiment (without participant or determinant weights applied) of discussions around each determinant outlined by a user or the enterprise. It serves as a transparent tool that empowers discussion initiators to gauge community or team opinions regarding the key factors driving the discussion. FIG. 5 shows a visual representation of the sentiment scores attributed to each determinant. In this specific example, participants expressed positive sentiments regarding the ‘Cost’ and ‘Usability’ aspects of the discussed feature design. However, they are notably critical of the ‘Configurability’ aspect of the design.

### Participant Weightage Assertion Over Participant Sentiment Dashboard

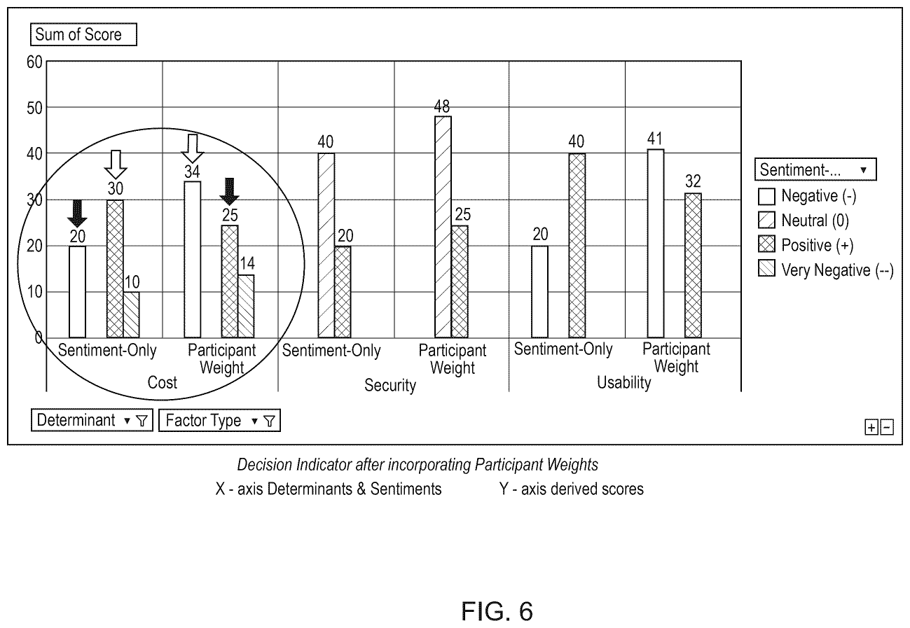

The ultimate decision-making process may not solely rely on prevailing sentiments in isolation. The overall sentiment expressed by participants can be influenced, altered, or superseded based on the significance of each participant's input. Participant weights, as defined in the enterprise application 205, may play an important role in reaching a relative decision. The visualization shown in FIG. 6 illustrates how a decision may be shaped by participant weights in relation to the general prevailing sentiment among all participants. While the general sentiment among participants regarding ‘Cost’ is positive, some participants with higher weights perceive the ‘Cost’ as high. Consequently, their sentiment leans towards the negative, diverging from the team's overall sentiment.

### Determinant Weightage Assertion Dashboard

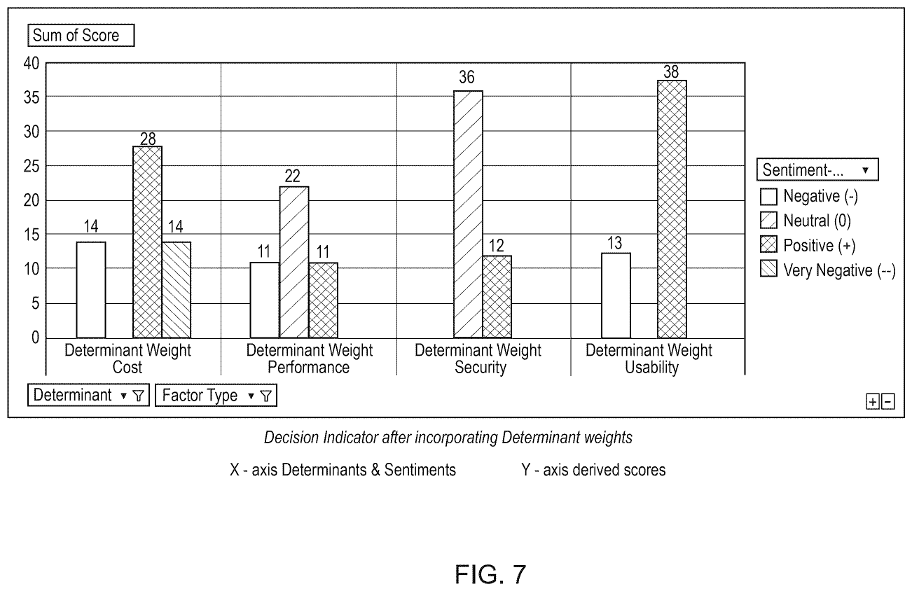

The importance of each determinant varies within a discussion event. The discussion initiator may assign weights to each determinant under discussion. The visualization shown in FIG. 7 illustrates how this enables the initiator to visualize the relative sentiments while taking into account the assigned determinant weights, which can prove to be very beneficial for making informed decisions.

### Comprehensive Indicator Dashboard

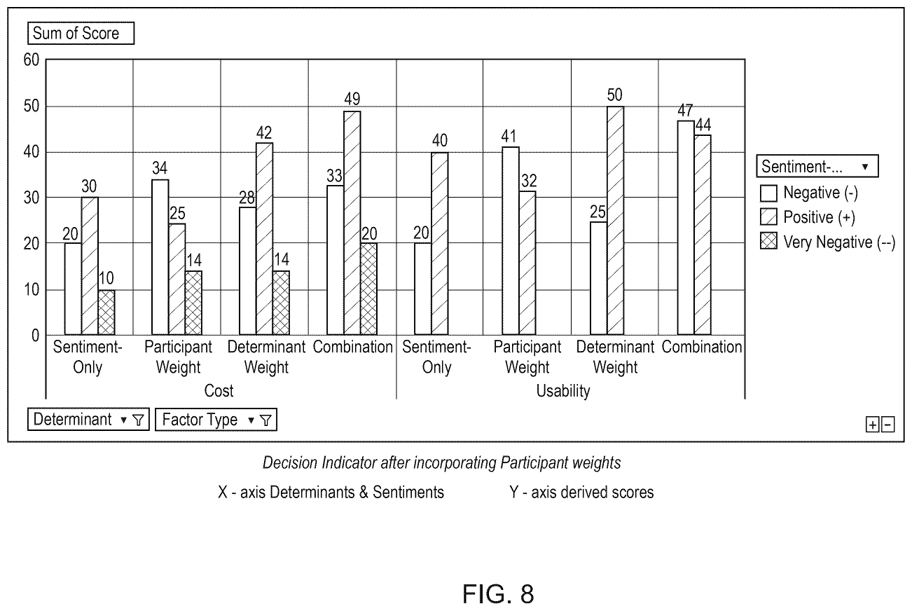

The comprehensive indicator consolidates multiple decision indicators (e.g., sentiment only, participant weightage, and determinant weightage) into a single visualization, providing detailed information. This visual aid assists discussion initiators in understanding how decision indicators and sentiments influence other factors, leading to transparent and informed decision-making process. The visualization shown in FIG. 8 on determinant ‘Usability’ shows different derived sentiments for various analysis

### AI Platform

FIG. 9 is a block diagram illustrating a AI platform 900 in accordance with various embodiments. The AI platform 900 in this example includes various stages: a training stage 910 to build and train models and an implementation stage 915 for implementing one or more models. The training stage 910 builds and trains one or more machine learning models 925a-925n (‘n’ represents any natural number) to be used by the other stages (which may be referred to herein individually as a prediction model 925 or collectively as the prediction models 925). For example, the prediction models 925 can include a model for predicting the sentiment of a participant. Still other types of prediction models may be implemented in other examples according to this disclosure such as generalized text-based sentiment analysis, aspect-based sentiment analysis, fine-grained sentiment analysis, sentiment classifier, and the like.

A prediction model 925 can be a machine-learning model, such as a convolutional neural network (“CNN”), e.g., an inception neural network, a residual neural network (“Resnet”), or a recurrent neural network, e.g., long short-term memory (“LSTM”) models or gated recurrent units (“GRUs”) models, other variants of Deep Neural Networks (“DNN”) (e.g., a multi-label n-binary DNN classifier or multi-class DNN classifier). A prediction model 925 can also be any other suitable ML model trained for providing a prediction, such as a Generalized linear model (GLM), Support Vector Machine, Bagging Models such as Random Forest Model, Boosting Models, Shallow Neural Networks, or combinations of one or more of such techniques—e.g., CNN-HMM or MCNN (Multi-Scale Convolutional Neural Network). The model system 900 may employ the same type of model or different types of models for various tasks such as sentiment analysis, named entity recognition, and/or classification.

To train the various prediction models 925, the training stage 910 is comprised of three main subsystems or services: dataset preparer 930, model trainer 940, and evaluator 945. The dataset preparer 930 performs the processes of loading data assets 950 (e.g., dataset of text samples labeled with sentiment categories such as positive, negative, neutral), splitting the data assets 950 into training and validation sets 950 a-n so that the system can train and test the prediction models 925, and preprocessing of training and validation sets 950 a-n. The splitting may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting. The training and validation sets 950 includes at least one dataset of text samples and/or pre-trained embeddings like Word2Vec, GloVe, or contextual embeddings like BERT, which capture semantic meaning. The preprocessing of training and validation sets 950 may include one or more of the following steps. Clean the text data by removing noise such as punctuation, special characters, and stop words. Tokenize the text into words or subwords. Convert the text data into numerical representations that can be fed into a deep learning model (e.g., using Bag-of-Words, Term Frequency-Inverse Document Frequency (TF-IDF), or Word Embeddings).

The model trainer 940 performs the processes of determining hyperparameters for the model 925 and performing iterative operations of inputting examples from the training data 945a into the model 925 to find a set of model parameters (e.g., weights and/or biases) that minimizes a cost function(s) such as loss or error function for the model 925. The hyperparameters are settings that can be tuned or optimized to control the behavior of the model 925. Most models explicitly define hyperparameters that control different features of the models such as memory or cost of execution. However, additional hyperparameters may be defined to adapt the model 925 to a specific scenario. For example, learning rate, number of iterations, regularization weight or strength, and the like. The cost function can be constructed to measure the difference between the outputs inferred using the model 925 and the ground truth annotated to the samples using the labels. For example, for a supervised learning-based model, the goal of the training is to learn a function “h( )” (also sometimes referred to as the hypothesis function) that maps the training input space X to the target value space Y, h: X→Y, such that h (x) is a good predictor for the corresponding value of y. Various different techniques may be used to learn this hypothesis function. In some techniques, as part of deriving the hypothesis function, the cost or loss function may be defined that measures the difference between the ground truth value for an input and the predicted value for that input. As part of training, techniques such as back propagation, random feedback, Direct Feedback Alignment (DFA), Indirect Feedback Alignment (IFA), Hebbian learning, and the like are used to minimize this cost or loss function.

Once the set of model parameters are identified, the model 925 has been trained and the evaluator 945 performs the additional processes of testing or validation using the subset of testing data 950b (testing or validation data set). The testing or validation processes includes iterative operations of inputting utterances from the subset of testing data 950b into the model 925 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set from the subset of test data 950a may be input into the model 925 to obtain output (in this example context, assign sentiment scores and/or classify the sentiment of expressed by a participant within a given text), and the output is evaluated versus ground truth entities using correlation techniques such as Bland-Altman method and the Spearman's rank correlation coefficients. Further, performance metrics 957 may be calculated in evaluation stage 915 such as the error, accuracy, precision, recall, receiver operating characteristic curve (ROC), etc. The metrics 957 may be used in the evaluator 945 to analyze performance of the model 925 for providing recommendations on training and hyperparameter optimization.

As should be understood, other training/validation mechanisms are contemplated and may be implemented within the model system 900. For example, the model 925 may be trained and model parameters may be tuned on data assets from a subset of obtained or filtered datasets and the datasets from a subset of obtained or filtered datasets may only be used for testing and evaluating performance of the model 925. Moreover, although the training mechanisms described herein focus on training a new model 925, these training mechanisms can also be utilized to fine tune existing models trained from other datasets. For example, in some instances, a model 925 might have been pre-trained using data assets from one or more different modalities or tasks. In those cases, the models 925 can be used for transfer learning and retrained/validated using the training and validating data as described above.

The model training stage 910 outputs trained models including one or more trained prediction models 960. The one or more trained prediction models 960 may be deployed and used in the implementation stage 915 for providing predictions 965 to users (see, e.g., the discussion of model in AI platform 215 with respect to FIG. 2). For example, prediction models 960 may receive input data 970 including descriptive text and/or definitive feedback and provide predictions 965 (e.g., assign sentiment scores and/or classify the sentiment of expressed by a participant within a given text) to a user based on features determined from the descriptive text and/or definitive feedback.

While not explicitly shown, it will be appreciated that the model system 900 may further include a developer device associated with a developer. Communications from a developer device to components of the model system 900 may indicate what types of descriptive text and/or definitive feedback are to be used for the models, a number and type of models to be used, hyperparameters of each model, for example, learning rate and number of hidden layers, how data requests are to be formatted, which training data is to be used (e.g., and how to gain access to the training data) and which validation technique is to be used, and/or how the controller processes are to be configured

### Techniques for Decision Support

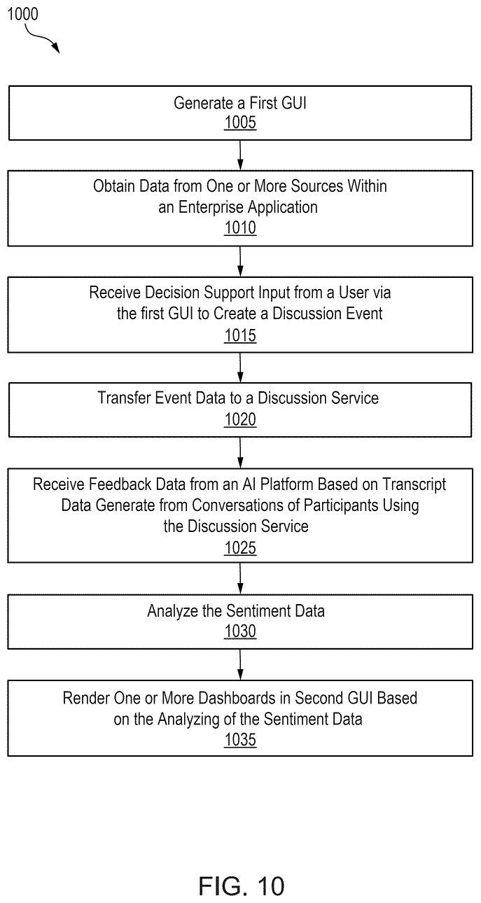

FIG. 10 depicts a simplified flowchart 1000 depicting a decision support process implemented by the RECA&DE architecture of FIG. 2 according to various embodiments. The processing depicted in FIG. 10 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 10 and described below is intended to be illustrative and non-limiting. Although FIG. 10 depicts the various processing steps occurring in a particular sequence or order, this is not intended to be limiting. In certain alternative embodiments, the steps may be performed in some different order, or some steps may also be performed in parallel.

The process commences in step 1005, where a first graphical user interface is generated for implementing a decision support module within an enterprise application. The first graphical user interface comprises one or more tools configured to allow a user to configure a discussion event.

At step 1010, data for the discussion event is obtained from one or more sources within the enterprise application based on input from the user received via the first graphical user interface. In some instances, the data for the discussion event from the one or more sources comprises a list of possible determinants. a list of possible participants, and information concerning each of the participants in the list of possible participants. The data for the discussion event from the one or more sources may be obtained using an Extract, Transform, Load (ETL) process, APIs, real-time streaming services, or any combination thereof, such that the data is consolidated from the one or more sources into a centralized data warehouse, ensuring data consistency and quality.

At step 1015, decision support input is received from the user via the first graphical user interface. The decision support input comprises a request to create the discussion event based on the data for the discussion event obtained from the one or more sources. The request defines participants to contribute to the discussion event, determinants, which are attributes that the discussion event is centered around, and weights for the participants, determinants, or both.

At step 1020, event data is transferred to a discussion service. The event data comprises the participants to contribute to the discussion event and the determinants.

At step 1025, feedback data is received from an artificial-intelligence platform. The feedback data comprises sentiment data derived by the artificial-intelligence platform based on transcript data generated from conversations of the participants using the discussion service. The transcript data comprises textual feedback of the participants on the determinants. In some instances, the feedback data comprises the sentiment data, quantitative or definite feedback, or both from each of the participants.

In some instances, the artificial-intelligence platform comprises one or more machine learning models trained for sentiment analysis of the transcript data. The sentiment analysis comprises assigning sentiment scores to descriptive comments in the transcript data, and the sentiment data comprises the sentiment scores assigned to the descriptive comments, sentiment scores derived from the quantitative or definite feedback, or both.

At step 1030, the feedback data is analyzed based on the participants, the determinants, and the weights for the participants, determinants, or both defined for the discussion event.

In some instances, analyzing the sentiment data comprises: accessing information for the participants including weights for the participants, information for the determinants including the weights for the determinants, and the sentiment scores assigned to the descriptive comments, sentiment scores derived from the quantitative or definite feedback, or both; and aggregating sentiment value by determinant based on the sentiment scores assigned to the descriptive comments, sentiment scores derived from the quantitative or definite feedback, or both.

In some instances, analyzing the sentiment data comprises: accessing information for the participants including weights for the participants, information for the determinants including the weights for the determinants, and the sentiment scores assigned to the descriptive comments, sentiment scores derived from the quantitative or definite feedback, or both; and determining a participant sentiment score for each determinant based on the weights for the participants and the sentiment scores assigned to the descriptive comments, sentiment scores derived from the quantitative or definite feedback, or both.

In some instances, analyzing the sentiment data comprises: accessing information for the participants including weights for the participants, information for the determinants including the weights for the determinants, and the sentiment scores assigned to the descriptive comments, sentiment scores derived from the quantitative or definite feedback, or both; and determining a determinant score for each determinant based on the weights for the determinants and the sentiment scores assigned to the descriptive comments, sentiment scores derived from the quantitative or definite feedback, or both.

In some instances, analyzing the sentiment data comprises determining both the participant sentiment score and the determinant score. In such instances, analyzing the sentiment data may further comprise combining the participant sentiment score and the determinant score into a comprehensive score.

At step 1035, one or more dashboards are rendered in a second graphical user interface based on the analyzing of the feedback data. The one or more dashboards visualize sentiment of the participants for each determinant based on sentiment only, participant weightage, determinant weightage, or any combination thereof.

### Illustrative Systems

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

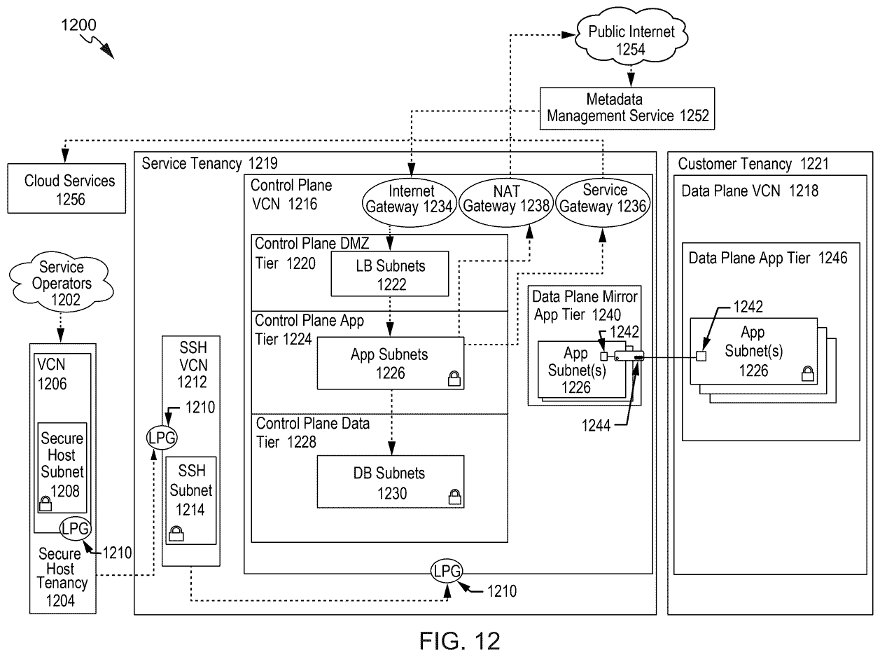

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

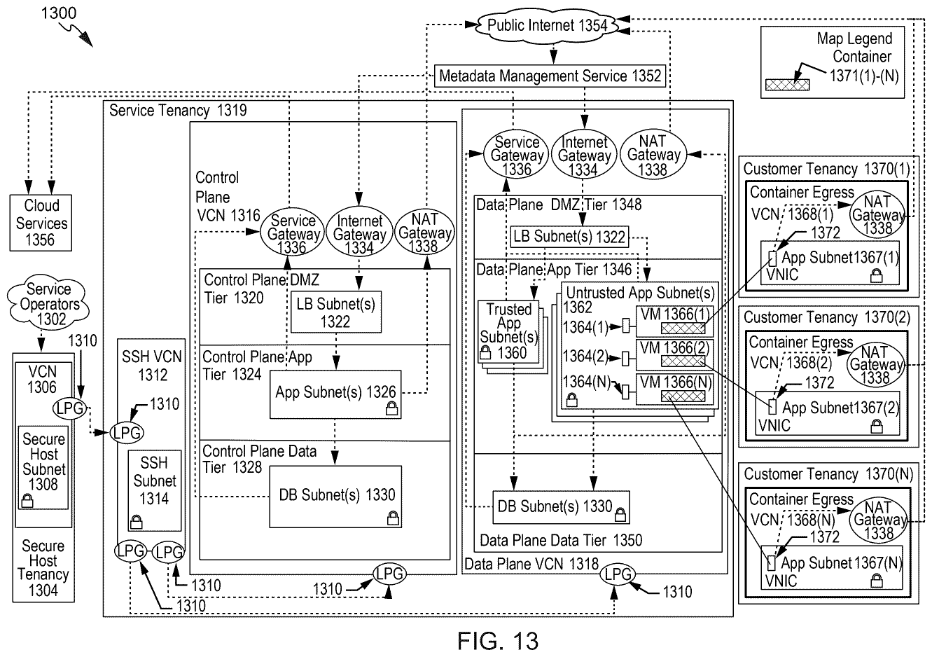

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

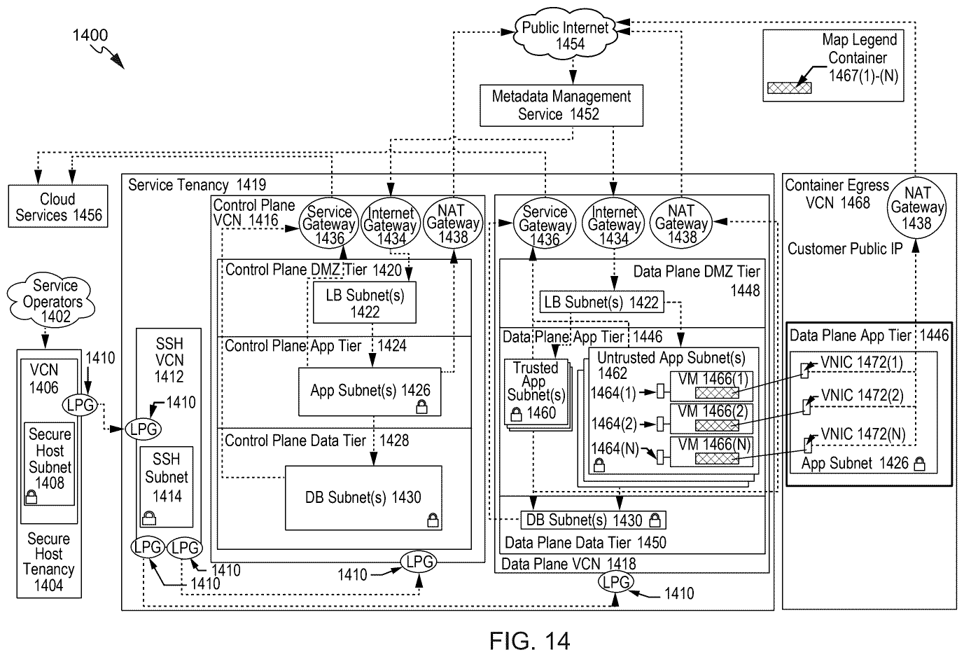

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICS 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

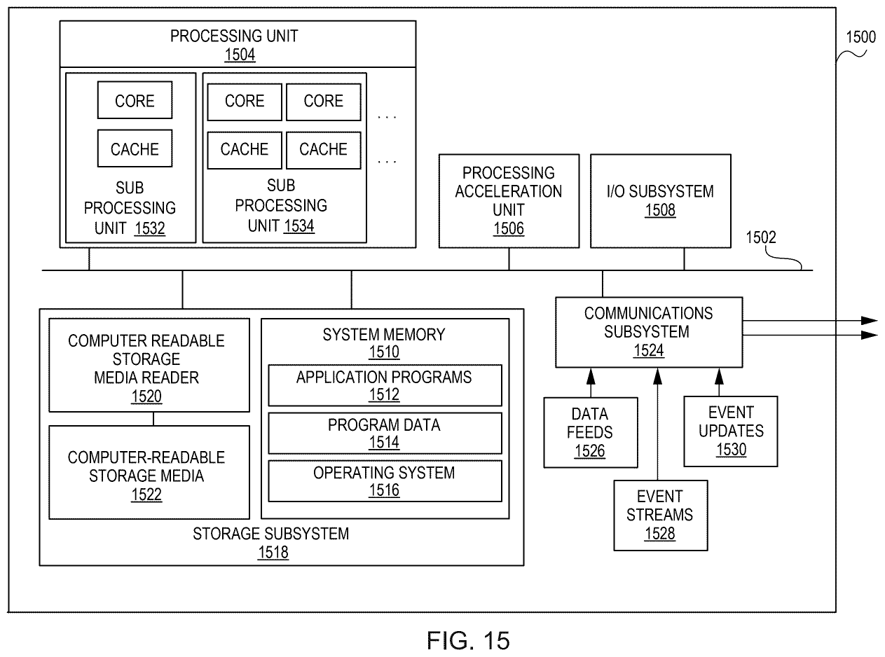

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc. Moreover, the term terms “about,” “similarly,” “substantially,” and “approximately” are used to provide flexibility to a numerical range endpoint by providing that a given value may be slightly above or slightly below the endpoint without affecting the desired result.

As used herein, when an action is “based on” something, this means the action can be based at least in part on at least a part of the something.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed:

1. A computer-implemented method comprising:
generating, by a data processing system, a first graphical user interface for implementing a decision support module within an enterprise application, wherein the first graphical user interface comprises one or more tools configured to allow a user to configure a discussion event;
obtaining, by the data processing system, data for the discussion event from one or more sources within the enterprise application based on input from the user received via the first graphical user interface;
receiving, by the data processing system, decision support input from the user via the first graphical user interface, wherein the decision support input comprises a request to create the discussion event based on the data for the discussion event obtained from the one or more sources, and wherein the request defines participants to contribute to the discussion event, determinants, which are attributes that the discussion event is centered around, and weights for the participants, determinants, or both;
transferring, by the data processing system, event data to a discussion service, wherein the event data comprises the participants to contribute to the discussion event and the determinants;
receiving, by the data processing system, feedback data from an artificial-intelligence platform, wherein the feedback data comprises sentiment data derived by the artificial-intelligence platform based on transcript data generated from conversations of the participants using the discussion service, and wherein the transcript data comprises textual feedback of the participants on the determinants;
analyzing, by the data processing system, the feedback data based on the participants, the determinants, and the weights for the participants, determinants, or both defined for the discussion event; and
rendering, by the data processing system, one or more dashboards in a second graphical user interface based on analyzing of the feedback data, wherein the one or more dashboards visualize sentiment of the participants for each determinant based on sentiment only, participant weightage, determinant weightage, or any combination thereof.

2. The computer-implemented method of claim 1, wherein the data for the discussion event from the one or more sources comprises a list of possible determinants. a list of possible participants, and information concerning each of the participants in the list of possible participants, and wherein the data for the discussion event from the one or more sources is obtained using an Extract, Transform, Load (ETL) process, APIs, real-time streaming services, or any combination thereof, such that the data is consolidated from the one or more sources into a centralized data warehouse, ensuring data consistency and quality.

3. The computer-implemented method of claim 1, wherein the feedback data comprises the sentiment data, quantitative or definite feedback, or both from each of the participants.

4. The computer-implemented method of claim 3, wherein the artificial-intelligence platform comprises one or more machine learning models trained for sentiment analysis of the transcript data, wherein the sentiment analysis comprises assigning sentiment scores to descriptive comments in the transcript data, and the sentiment data comprises the sentiment scores assigned to the descriptive comments, sentiment scores derived from the quantitative or definite feedback, or both.

5. The computer-implemented method of claim 4, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
aggregating sentiment value by determinant based on the sentiment scores assigned to the descriptive comments, sentiment scores derived from the quantitative or definite feedback, or both.

6. The computer-implemented method of claim 4, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
determining a participant sentiment score for each determinant based on the weights for the participants and the sentiment scores assigned to the descriptive comments, sentiment scores derived from the quantitative or definite feedback, or both.

7. The computer-implemented method of claim 4, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
determining a determinant score for each determinant based on the weights for the determinants and the sentiment scores assigned to the descriptive comments, sentiment scores derived from the quantitative or definite feedback, or both.

8. A system comprising:
one or more processors;
one or more computer-readable media storing instructions which, when executed by the one or more processors, cause the system to perform operations comprising:
generating, by a data processing system, a first graphical user interface for implementing a decision support module within an enterprise application, wherein the first graphical user interface comprises one or more tools configured to allow a user to configure a discussion event;
obtaining, by the data processing system, data for the discussion event from one or more sources within the enterprise application based on input from the user received via the first graphical user interface;
receiving, by the data processing system, decision support input from the user via the first graphical user interface, wherein the decision support input comprises a request to create the discussion event based on the data for the discussion event obtained from the one or more sources, and wherein the request defines participants to contribute to the discussion event, determinants, which are attributes that the discussion event is centered around, and weights for the participants, determinants, or both;
transferring, by the data processing system, event data to a discussion service, wherein the event data comprises the participants to contribute to the discussion event and the determinants;
receiving, by the data processing system, feedback data from an artificial-intelligence platform, wherein the feedback data comprises sentiment data derived by the artificial-intelligence platform based on transcript data generated from conversations of the participants using the discussion service, and wherein the transcript data comprises textual feedback of the participants on the determinants;
analyzing, by the data processing system, the feedback data based on the participants, the determinants, and the weights for the participants, determinants, or both defined for the discussion event; and
rendering, by the data processing system, one or more dashboards in a second graphical user interface based on analyzing of the feedback data, wherein the one or more dashboards visualize sentiment of the participants for each determinant based on sentiment only, participant weightage, determinant weightage, or any combination thereof.

9. The system of claim 8, wherein the data for the discussion event from the one or more sources comprises a list of possible determinants. a list of possible participants, and information concerning each of the participants in the list of possible participants, and wherein the data for the discussion event from the one or more sources is obtained using an Extract, Transform, Load (ETL) process, APIs, real-time streaming services, or any combination thereof, such that the data is consolidated from the one or more sources into a centralized data warehouse, ensuring data consistency and quality.

10. The system of claim 8, wherein the feedback data comprises the sentiment data, quantitative or definite feedback, or both from each of the participants.

11. The system of claim 10, wherein the artificial-intelligence platform comprises one or more machine learning models trained for sentiment analysis of the transcript data, wherein the sentiment analysis comprises assigning sentiment scores to descriptive comments in the transcript data, and the sentiment data comprises the sentiment scores assigned to the descriptive comments, sentiment scores derived from the quantitative or definite feedback, or both.

12. The system of claim 11, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
aggregating sentiment value by determinant based on the sentiment scores assigned to the descriptive comments, sentiment scores derived from the quantitative or definite feedback, or both.

13. The system of claim 11, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
determining a participant sentiment score for each determinant based on the weights for the participants and the sentiment scores assigned to the descriptive comments, sentiment scores derived from the quantitative or definite feedback, or both.

14. The system of claim 11, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
determining a determinant score for each determinant based on the weights for the determinants and the sentiment scores assigned to the descriptive comments, sentiment scores derived from the quantitative or definite feedback, or both.

15. One or more non-transitory computer-readable media storing instructions which, when executed by one or more processors, cause a system to perform operations comprising:
generating, by a data processing system, a first graphical user interface for implementing a decision support module within an enterprise application, wherein the first graphical user interface comprises one or more tools configured to allow a user to configure a discussion event;
obtaining, by the data processing system, data for the discussion event from one or more sources within the enterprise application based on input from the user received via the first graphical user interface;
receiving, by the data processing system, decision support input from the user via the first graphical user interface, wherein the decision support input comprises a request to create the discussion event based on the data for the discussion event obtained from the one or more sources, and wherein the request defines participants to contribute to the discussion event, determinants, which are attributes that the discussion event is centered around, and weights for the participants, determinants, or both;
transferring, by the data processing system, event data to a discussion service, wherein the event data comprises the participants to contribute to the discussion event and the determinants;
receiving, by the data processing system, feedback data from an artificial-intelligence platform, wherein the feedback data comprises sentiment data derived by the artificial-intelligence platform based on transcript data generated from conversations of the participants using the discussion service, and wherein the transcript data comprises textual feedback of the participants on the determinants;
analyzing, by the data processing system, the feedback data based on the participants, the determinants, and the weights for the participants, determinants, or both defined for the discussion event; and
rendering, by the data processing system, one or more dashboards in a second graphical user interface based on analyzing of the feedback data, wherein the one or more dashboards visualize sentiment of the participants for each determinant based on sentiment only, participant weightage, determinant weightage, or any combination thereof.

16. The one or more non-transitory computer-readable media of claim 15, wherein the data for the discussion event from the one or more sources comprises a list of possible determinants. a list of possible participants, and information concerning each of the participants in the list of possible participants, and wherein the data for the discussion event from the one or more sources is obtained using an Extract, Transform, Load (ETL) process, APIs, real-time streaming services, or any combination thereof, such that the data is consolidated from the one or more sources into a centralized data warehouse, ensuring data consistency and quality.

17. The one or more non-transitory computer-readable media of claim 15, wherein the feedback data comprises the sentiment data, quantitative or definite feedback, or both from each of the participants.

18. The one or more non-transitory computer-readable media of claim 17, wherein the artificial-intelligence platform comprises one or more machine learning models trained for sentiment analysis of the transcript data, wherein the sentiment analysis comprises assigning sentiment scores to descriptive comments in the transcript data, and the sentiment data comprises the sentiment scores assigned to the descriptive comments, sentiment scores derived from the quantitative or definite feedback, or both.

19. The one or more non-transitory computer-readable media of claim 17, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
aggregating sentiment value by determinant based on the sentiment scores assigned to the descriptive comments, sentiment scores derived from the quantitative or definite feedback, or both.

20. The one or more non-transitory computer-readable media of claim 17, wherein analyzing the sentiment data comprises:
accessing information for the participants including weights for the participants, information for the determinants including the weights for the determinants, and the sentiment scores assigned to the descriptive comments, sentiment scores derived from the quantitative or definite feedback, or both; and
determining a participant sentiment score for each determinant based on the weights for the participants and the sentiment scores assigned to the descriptive comments, sentiment scores derived from the quantitative or definite feedback, or both.
